(19) United States
(12) Patent Application Publication
(10) Pub. No.: US 2022/0301424 A1
(43) Pub. Date: Sep. 22, 2022

(54) CONTROL SYSTEM, TRAVELING CONTROLLER, AND CONTROLLING METHOD

(71) Applicant: Hitachi, Ltd., Tokyo (JP)

(72) Inventors: Hidenori SAKANIWA, Tokyo (JP); Akihiko HYODO, Tokyo (JP); Takashi MATSUMOTO, Tokyo (JP); Akihiro KONDO, Tokyo (JP)

(21) Appl. No.: 17/680,054

(22) Filed: Feb. 24, 2022

(30) Foreign Application Priority Data
Mar. 17, 2021 (JP) 2021-043163

(51) Int. Cl. G08G 1/01; G08G 1/056; G08G 1/017; G08G 1/052; G08G 1/0968

(52) U.S. Cl. CPC G08G 1/0145; G08G 1/0125; G08G 1/056; G08G 1/017; G08G 1/052; G08G 1/096844

(57) ABSTRACT

Provided is a control system that can realize an efficient operation of a traveling body. The control system includes: a traveling route control unit configured to control information on a traveling path on which a traveling body travels; a traveling body position control unit configured to communicate with the traveling body and configured to control at least positional information on the traveling body; a lane setting unit configured to dynamically set a lane on the traveling path using at least the positional information on the traveling body and a size of the traveling body; and a control information setting unit configured to set control information for controlling traveling of the traveling body in the lane. The control system realizes an efficient operation of the traveling body.

### BACKGROUND

The present invention relates to a control system, a traveling controller and, a controlling method.

Conventionally, for controlling traveling of a vehicle, there has been proposed a technique disclosed in Japanese Unexamined Patent Application Publication No. 2019-111882. In this publication, there is a description “A vehicle controller includes: a first recognition unit configured to recognize one or more other vehicles existing around an own vehicle; a second recognition unit configured to recognize that a road on which the own vehicle travels is a road that does not have a center line; an estimation unit configured to estimate a state of a driver of an oncoming vehicle that faces the own vehicle among the one or more other vehicles recognized by the first recognition unit; a determination unit configured to determine whether or not the oncoming vehicle recognized by the first recognition unit is a vehicle that is traveling by a manual operation; and a control unit configured to decelerate the own vehicle to a predetermined speed or below based on a state of the driver of the oncoming vehicle when the oncoming vehicle is traveling by a manual operation and the road on which the own vehicle travels is the road that does not have the center line”.

### SUMMARY

The above-mentioned prior art can support passing by of the own vehicle with the oncoming vehicle on a road having no center line. However, the prior art is not intended to make the entire operation of the traveling body efficient. In recent years, a position and a speed of a traveling body can be controlled with high accuracy. However, such a control with high accuracy is not reflected on a traveling path on which a traveling body travels and hence, the operation in accordance with the traveling path has a limit in the enhancement of efficiency. The traveling body may be a vehicle, for example. Lanes are provided to a road that is a traveling path in accordance with a conventional standard, and traveling of a vehicle is controlled using one lane as a unit. As another case, a working robot may be a traveling body, for example. In this case, a lane having a width that allows the largest working robot to travel is provided to a zone that is a traveling path disposed in an area of a plant.

It is an object of the present invention to realize an efficient operation of a traveling body.

To achieve the above-mentioned object, one typical control system according to the present invention includes: a traveling route control unit configured to control information on a traveling path on which a traveling body travels; a traveling body position control unit configured to communicate with the traveling body and configured to control at least positional information on the traveling body; a lane setting unit configured to dynamically set a lane on the traveling path using at least positional information on the traveling body and a size of the traveling body; and a control information setting unit configured to set control information for controlling traveling of the traveling body in the lane.

One typical traveling controller according to the present invention is a traveling controller mounted on a traveling body that travels on a traveling path. The traveling controller includes: a communication unit configured to communicate with a control center; a positional information notification unit configured to acquire positional information on an own traveling body and configured to transmit the positional information via the communication unit; and a traveling control unit configured to acquire information on a lane dynamically set in the traveling path and control information set with respect to the lane from the control center and configured to control traveling of the own traveling body.

One typical controlling method according to the present invention includes: a traveling path control step of controlling information on a traveling path on which a traveling body travels; a traveling body position control step of communicating with the traveling body and of controlling at least positional information on the traveling body; a lane setting step of dynamically setting a lane on the traveling path using at least positional information on the traveling body and a size of the traveling body; and a control information setting step of setting control information for controlling traveling of the traveling body in the lane.

According to the present invention, it is possible to realize an efficient operation of the traveling body. Objects, configurations and advantageous effects other than the above will become apparent based on the description of an embodiment made hereinafter.

### BRIEF DESCRIPTION OF THE DRAWINGS

FIG. 1 is a configurational view of a control system according to an embodiment;

FIG. 2 is an explanatory view for describing a traveling control performed by a control center;

FIG. 3 is a flowchart showing the detail of initialization of a control database;

FIG. 4 is an explanatory view for describing registration of degree of priority;

FIG. 5 is an explanatory view for describing a speed of a vehicle and a virtual lane of the vehicle;

FIG. 6 is an explanatory view for describing a data structure of control information;

FIG. 7 is a flowchart for describing processing for changing a route;

FIG. 8 is a block diagram illustrating a specific example of changing the route;

FIG. 9 is a block diagram illustrating a specific example of an operation screen of a control UI;

FIG. 10 is a block diagram illustrating a specific example of passing control at an intersection;

FIG. 11 is an explanatory view for describing passing control of vehicles traveling in the same direction;

FIG. 12 is an explanatory view for describing a case where the direction of a lane is switched;

FIG. 13 is a chart for describing a specific example of control information that realizes the passing control illustrated in FIG. 12 (first example);

FIG. 14 is a chart for describing a specific example of control information that realizes the passing control illustrated in FIG. 12 (second example);

FIG. 15 is an explanatory view for describing an overtake control;

FIG. 16 is a chart for describing a specific example of control information that realizes the passing control illustrated in FIG. 15; and

FIG. 17 is an explanatory view for describing a traveling control of a working robot.

### DETAILED DESCRIPTION

An embodiment of the present invention is described with reference to drawings hereinafter.

### Embodiment

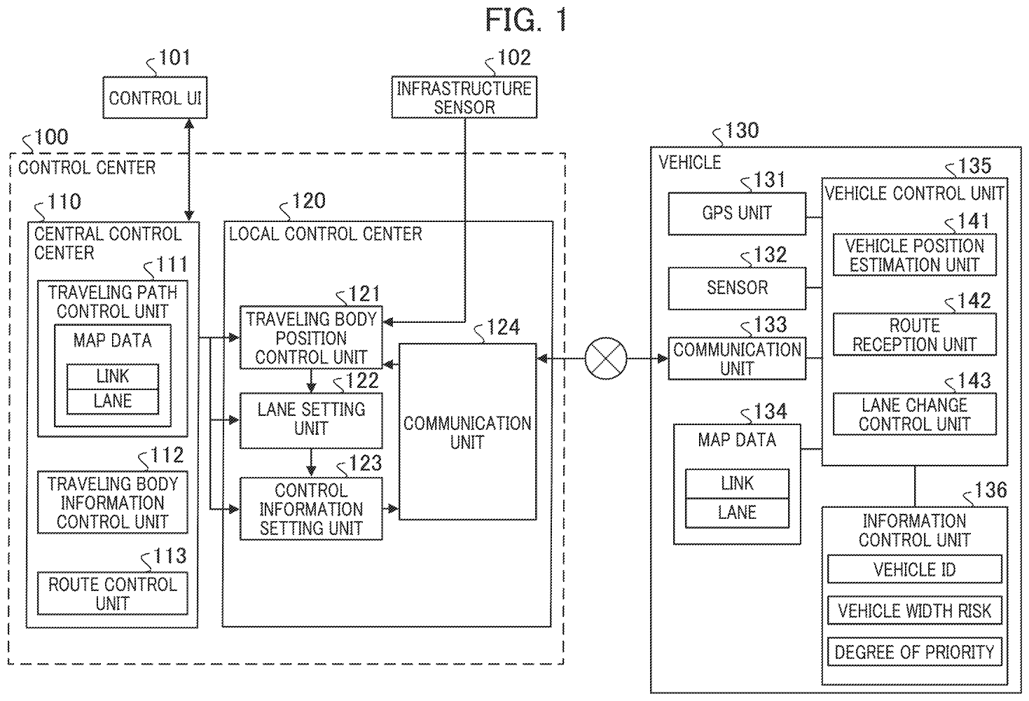

FIG. 1 is a configurational view of a control system according to an embodiment. As shown in FIG. 1, the control system is formed by connecting a control center 100 and a vehicle 130 that is a traveling body via a communication network.

The control center 100 has a central control center 110 and one or a plurality of local control centers 120. The central control center 110 receives an operation of an operator by a control user interface (UI) 101. The central control center includes a traveling route control unit 111, a traveling body information control unit 112, and a route control unit 113.

The local control center 120 acquires sensor outputs from a plurality of infrastructure sensors 102 set on a traveling path. The local control center 120 includes a traveling body position control unit 121, a lane setting unit 122, a control information setting unit 123, and a communication unit 124.

The traveling route control unit 111 controls information on the traveling path on which the traveling body travels as map data. The map data contains information on a link that identifies a road on which a vehicle travels, information on existing lanes statically set on the road, and the like as information on the traveling path.

The traveling body information control unit 112 is a unit that controls information relating to the traveling body. The traveling body is a vehicle 130, for example. Information set with respect to the traveling body contains an actual vehicle width, an actual vehicle length, the degree of priority, and the like.

The route control unit 113 performs a route control by setting the destination and the route of the traveling body. Specifically, the route control unit 113 can set the route on which the vehicle 130 is scheduled to travel using a present place and the destination of the vehicle 130 and by referencing the map data controlled by the traveling route control unit 111. The route control unit 113, in controlling the routes of a plurality of vehicles 130, can realize a smooth and efficient operation of the plurality of vehicles 130 by setting the destinations and the routes of the plurality of vehicles 130 in a comprehensive manner.

The traveling body position control unit 121 controls the positions of the plurality of vehicles 130, the positions of obstacles on the traveling paths, and the like using an output from the infrastructure sensor 102 and positional information received from the plurality of the vehicles 130. The traveling body position control unit 121 can also control the acquisition of information such as a speed of the traveling body.

The lane setting unit 122 dynamically sets the lane on the traveling path using at least the positional information on the traveling body and the size of the traveling body. The positional information on the traveling body can be obtained from the traveling body position control unit 121. It is also possible to acquire a speed of the traveling body from the traveling body position control unit 121. A size of the traveling body and the like can be obtained from the traveling body information control unit 112.

Specifically, the lane setting unit 122 dynamically sets a virtual lane with respect to a road indicated in the map data. Priority can be assigned to the virtual lane that is virtual to a static lane contained in the map data. Although described later in detail, the lane setting unit 122 sets a virtual vehicle width by taking into account a traveling speed of the traveling body with respect to a vehicle width of the traveling body and sets the virtual vehicle width as a width of the virtual lane. Further, the lane setting unit 122 performs zoning of the lane at every predetermined length. The predetermined length may be a fixed value or may be obtained based on a vehicle length.

The control information setting unit 123 sets control information for controlling the traveling in the virtual lane set by the lane setting unit 122. The control information is set for every zone. The control information is set corresponding to the degrees of priority set to the traveling bodies existing on the lane and lanes in the periphery of the lane. By setting the control information in this manner, for example, in a case where a plurality of traveling bodies having different degrees of priority travel in the same direction, one of the plurality of virtual lanes is set as an overtaking lane. Accordingly, it is possible to allow the traveling body having a high degree of priority to change the lane to the overtaking lane and to overtake the traveling body having a low degree of priority.

The communication unit 124 is a communication interface used for communication with the plurality of vehicles 130. For example, the reception of positional information and speed information from the vehicle 130 and the transmission of the route information and the degree of priority with respect to the vehicle 130 are performed via the communication unit 124.

The vehicle 130 includes a global positioning system (GPS) unit 131, a sensor 132, a communication unit 133, map data 134, a vehicle control unit 135, information control unit 136, and the like.

The GPS unit 131 is a unit that identifies the positional information by receiving a signal from a GPS artificial satellite. The sensor 132 is used for detecting a state of the own vehicle and a state of the surrounding of the own vehicle. The communication unit 133 is a communication interface used for communication with the control center 100. For example, the transmission of the positional information and speed information to the control center 100 and reception of route information, the degree of priority, and the like from the control center 100 are performed via the communication unit 133. The map data 134 contains information on a link that identifies a road on which the vehicle travels, information on an existing lane statically set on the road, and the like as information on the traveling path.

The vehicle control unit 135 has a function of a positional information notification unit that acquires positional information on the own traveling body and transmits the positional information via the communication unit 133, and has a function of a traveling control unit that acquires information on the virtual lane and the control information from the control center 100 and controls traveling of the vehicle.

As an example, the vehicle control unit 135 includes functional units such as a vehicle position estimation unit 141, a route reception unit 142, and a lane change control unit 143. The vehicle position estimation unit 141 estimates with high accuracy the position of the own vehicle using the positional information acquired using the GPS unit 131, an output of the sensor 132, and the like. The estimated positional information is used for the transmission to the control center 100 and for a traveling control of the own vehicle. The route reception unit 142 receives a route on which the own vehicle is scheduled to travel from the control center 100 and controls the route. The lane change control unit 143 realizes a lane change by controlling traveling of the vehicle in accordance with a virtual lane designated by the control center 100 and control information.

The information control unit 136 controls various kinds of information which are necessary for traveling in association with the control center 100 such as a vehicle ID by which the own vehicle is identified, a vehicle width risk determined based on an actual vehicle width and a speed, and the degree of priority designated by the control center 100.

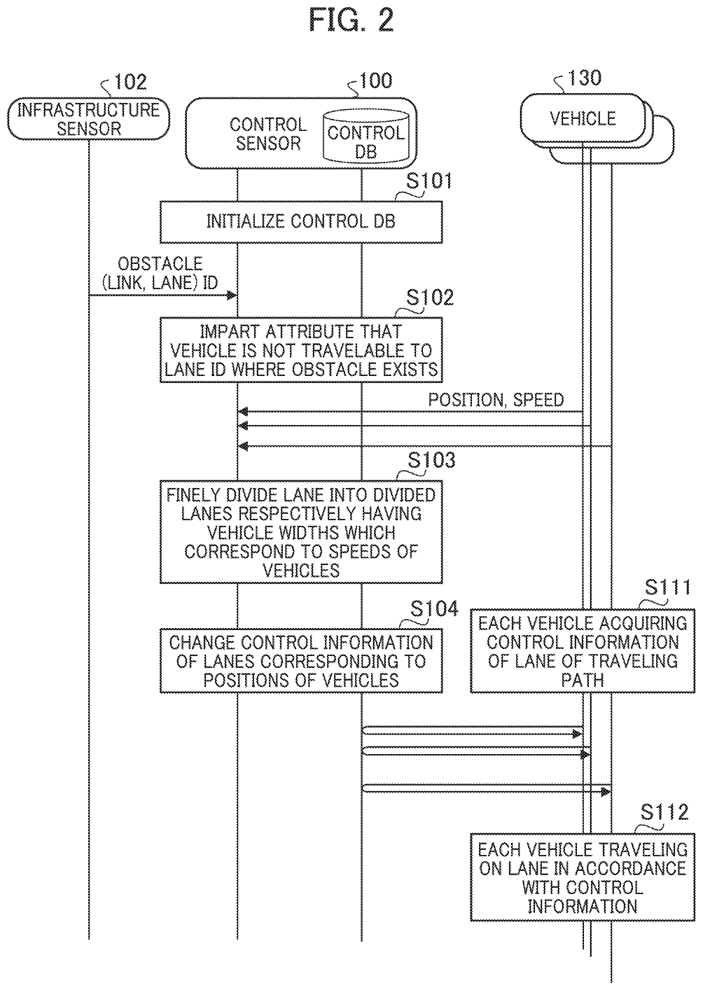

FIG. 2 is an explanatory view for describing a traveling control performed by the control center 100. As shown in FIG. 2, the control center 100 initializes control database stored in map data or the like (step S101) and, thereafter, acquires information on places where obstacles exist by the infrastructure sensor 102. The places where the obstacles exist are identified using identification information (ID) of the link and the lane. The control center 100 imparts an attribute that a vehicle is not travelable to the lane ID where an obstacle exists (step S102).

The control center 100 acquires information on the positions and the speeds from the plurality of vehicles 130 that are under control of the control center 100. The control center 100 finely divides the lane into divided lanes respectively having vehicle widths that correspond to speeds of the vehicles 130 (step S103), and changes control information on the divided lanes corresponding to the positions of the vehicles (step S104).

Each vehicle 130 acquires control information on the lane of the traveling route of the own vehicle (step S111), and travels on the lane in accordance with the acquired control information (step S112).

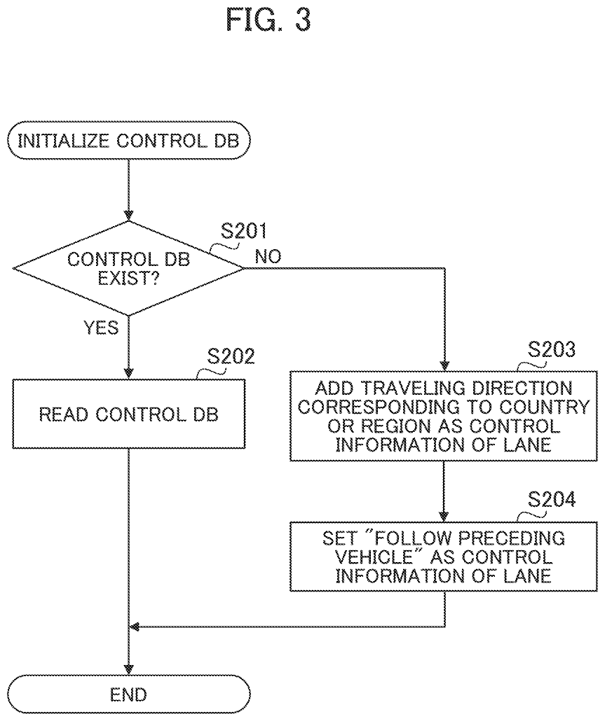

FIG. 3 is a flowchart showing the detail of initialization of a control database. The control center 100 confirms whether or not the control database that is already prepared exists when initialization processing of the control database is started (step S201).

When the prepared control database exists (step S201; Yes), the control center 100 reads the prepared control database (step S202), and finishes the processing.

When the prepared control database does not exist (step S201; No), the control center 100 adds a traveling direction corresponding to a country or a region as control information on a lane (step S203), adds “follow preceding vehicle” to each lane as control information (step S204), and finishes the processing.

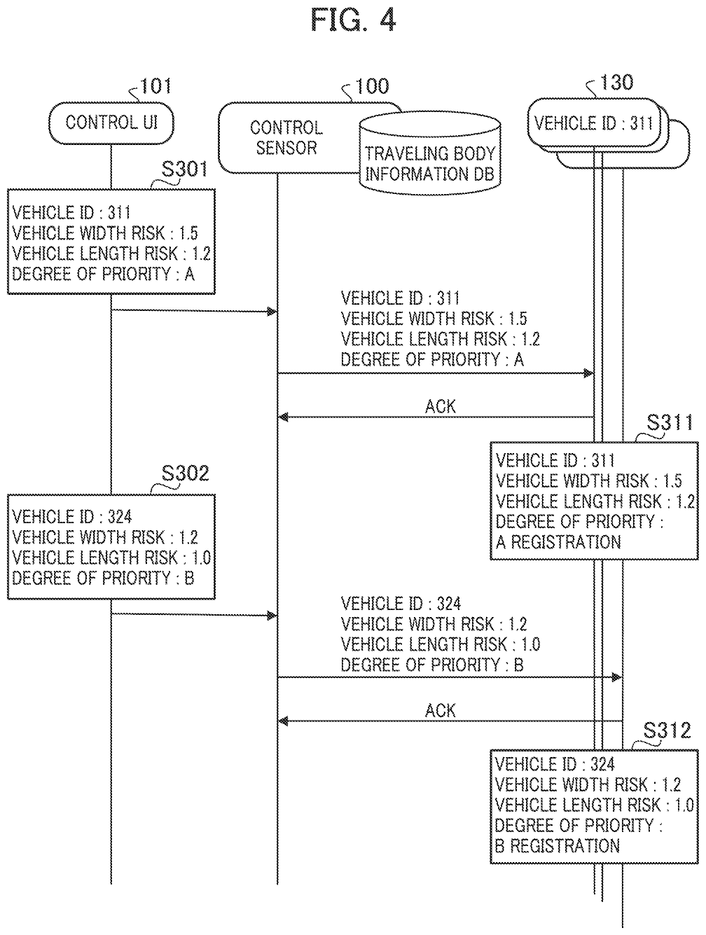

FIG. 4 is an explanatory view for describing the registration of the degree of priority. In FIG. 4, first, a control UI 101 receives inputting of “vehicle ID:311, vehicle width risk: 1.5, vehicle length risk: 1.2, degree of priority: A” from an operator. In such data inputting, the degree of priority has the relationship of A>B>C where the highest degree of priority is assigned to “A”.

The control center 100 transmits the received input to the vehicle 130 corresponding to the input, and receives an acknowledgement (ACK) from the vehicle 130. The vehicle 130 having the vehicle ID “311” registers the data that the vehicle 130 receives from the control center 100 in the information control unit 136 (step S311).

Next, the control UI 101 receives inputting of “vehicle ID: 324, vehicle width risk: 1.2, vehicle length risk: 1.0, degree of priority: B” from the operator.

The control center 100 transmits the received input to the vehicle 130 corresponding to the input, and receives an ACK from the vehicle 130. The vehicle 130 having a vehicle ID “324” registers the data that the vehicle 130 receives from the control center 100 in the information control unit 136 (step S312).

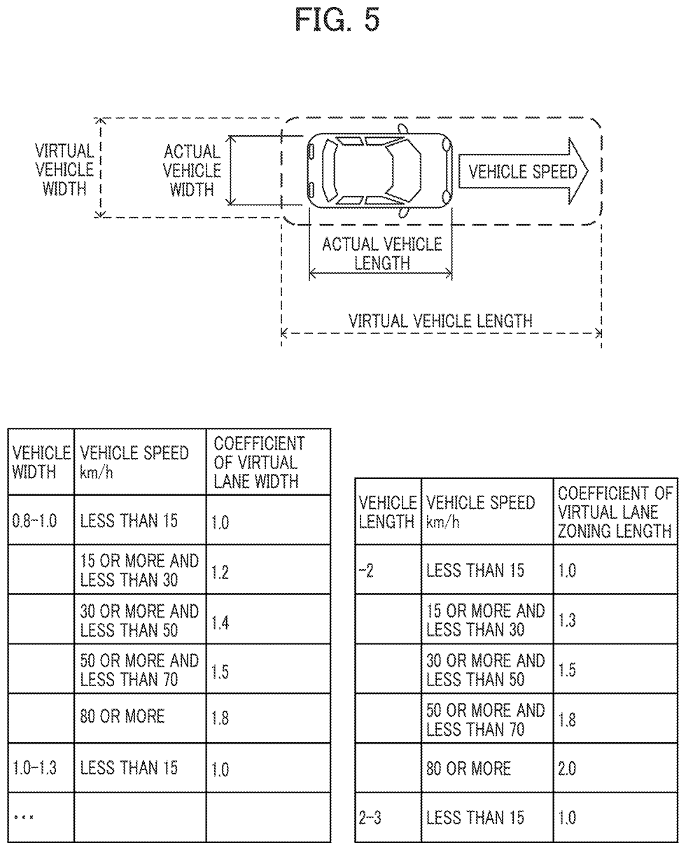

FIG. 5 is an explanatory view for describing a speed of a vehicle and a virtual lane of the vehicle. The control center 100 sets a virtual vehicle width larger than an actual vehicle width that is a vehicle width of an actual vehicle. An extent of increase of the virtual vehicle width is determined based on a vehicle speed, and the virtual vehicle width is used as a width of the virtual lane.

In FIG. 5, as an example, it is indicated that when the actual vehicle width is 0.8 m to 1.0 m inclusive and a vehicle speed is less than 15 km/h, “1.0” is used as a coefficient of a virtual lane width. In the same manner, it is indicated that when the actual vehicle width is 0.8 m to 1.0 m inclusive and the vehicle speed is 15 km/h or more and less than 30 km/h, “1.2” is used as a coefficient of the virtual lane width.

The control center 100 sets a virtual vehicle length larger than an actual vehicle length that is a vehicle length of an actual vehicle. An extent of an increase of the virtual vehicle length is determined based on a vehicle speed, and the virtual vehicle length is used as a length of a zone of the virtual lane.

In FIG. 5, as an example, it is indicated that when the actual vehicle length is less than 2 m and a vehicle speed is less than 15 km/h, “1.0” is used as a coefficient of a zoning length of the virtual lane. In the same manner, it is indicated that when the actual vehicle length is less than 2 m and the vehicle speed is 15 km/h or more and less than 30 km/h, “1.3” is used as a coefficient of the zoning length of the virtual lane.

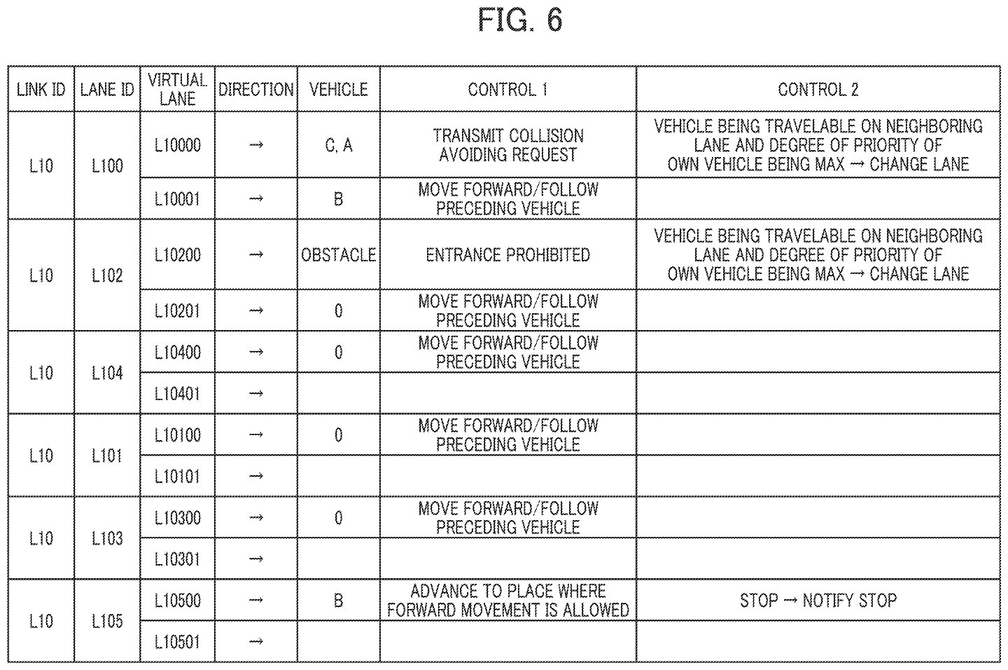

FIG. 6 is an explanatory view for describing the data structure of control information. As shown in FIG. 6, the control information includes a link ID, a lane ID, a virtual lane, a direction, a vehicle, a control 1, and a control 2. The link ID is identification information that identifies a road on a map data. The lane ID is identification information that identifies a static lane on the map data. The virtual lane ID is identification information that identifies a virtual lane that the lane setting unit 122 sets.

The direction is the traveling direction set with respect to the virtual lane. A vehicle is allowed to travel in the direction set to the virtual lane. Further, the traveling direction on the virtual lane can be switched by the control center 100.

The vehicle indicates a vehicle that currently exists on the virtual lane. For example, in a case where “C, A” are described in the column “vehicle”, this implies that there exist two vehicles consisting of the vehicle having the degree of priority C and the vehicle having the degree of priority A. Further, in a case where an obstacle exists, such an obstacle is registered in the column of the vehicle.

The control 1 and the control 2 define modes in which a vehicle existing on the virtual lane travels. In the control 1, controls such as “move forward/follow preceding vehicle”, “transmit collision avoiding request”, “entrance prohibited”, “advance to place where forward movement is allowed” are registered. In the control 2, “change lane when the own vehicle is travelable and the degree of priority of the own vehicle is “MAX”, “notify stop of the vehicle to the control center 100 after the own vehicle is stopped”, and the like are registered.

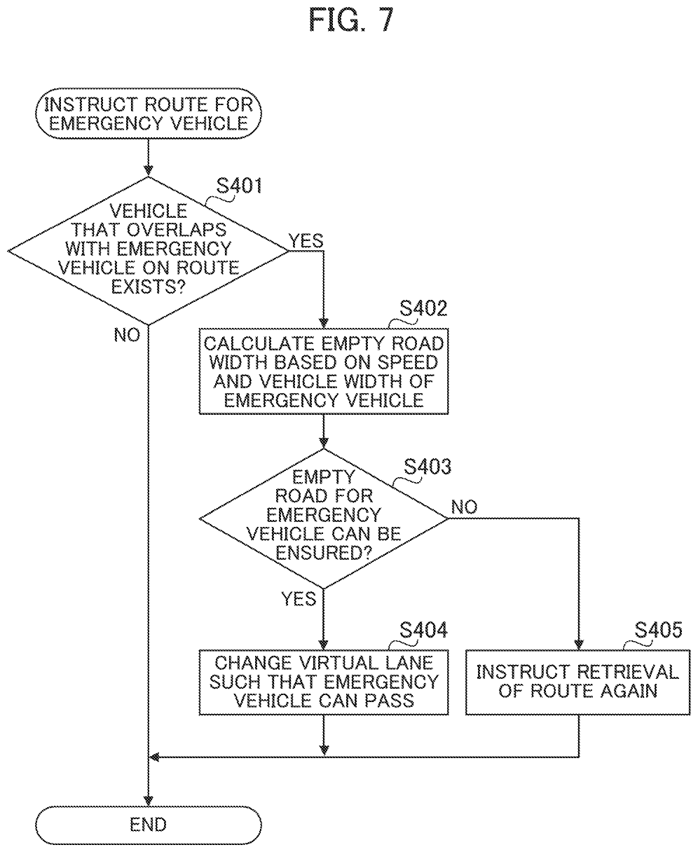

FIG. 7 is a flowchart for describing processing for changing a route. The control center 100 (for example, the traveling route control unit 111), when a route on which an emergency vehicle having a high degree of priority is indicated, determines whether or not a vehicle that overlaps with the emergency vehicle on the route exists (step S201).

When the vehicle that overlaps with the emergency vehicle does not exist on the route (step S401; No), the control center 100 directly finishes the processing. When the vehicle that overlaps with the emergency vehicle exists on the route (step S401; Yes), the control center 100 calculates an empty road width necessary for passing of the emergency vehicle based on a speed and a vehicle width of the emergency vehicle (step S402).

After step S402, the control center 100 determines whether or not an empty road for the emergency vehicle can be ensured (step S403). When the empty road for the emergency vehicle can be ensured (step S403; Yes), the control center 100 changes the virtual lane such that the emergency vehicle can pass (step S404), and finishes the processing. When the control center 100 cannot ensure the empty road for the emergency vehicle (step S403; No), the control center 100 instructs again a retrieval of a route on which the vehicle overlapping with the emergency vehicle can pass (step S405), and finishes the processing.

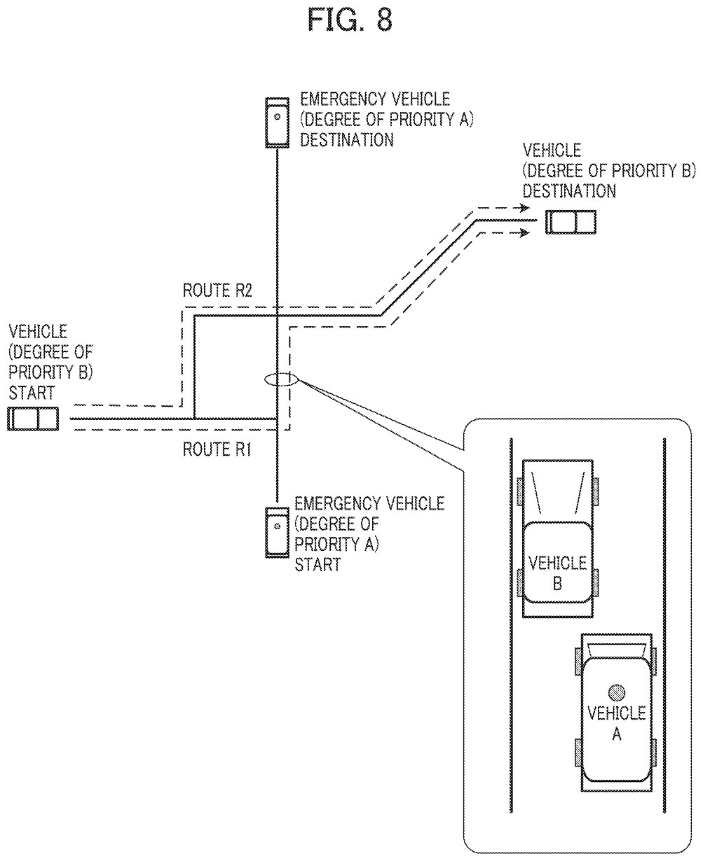

FIG. 8 is block diagram illustrating a specific example of changing the route. In FIG. 8, a vehicle having the degree of priority B is scheduled to travel on a route R1. However, the route R1 overlaps with a route of an emergency vehicle having the degree of priority A. Then, based on a relationship among a road width, a vehicle width of the vehicle having the degree of priority B, and a speed and a vehicle width of the emergency vehicle having the degree of priority A, the road cannot be ensured for the emergency vehicle and hence, the path of the vehicle having the degree of priority B is changed to the route R2.

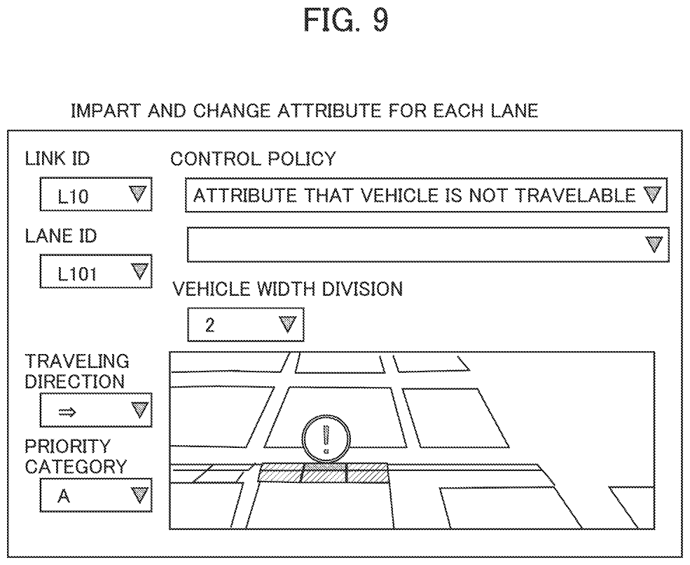

FIG. 9 is block diagram illustrating a specific example of an operation screen of the control UI 101. The operation screen illustrated in FIG. 9 includes input items such as a link ID and a lane ID of map data, a control policy as control information, a vehicle width division that indicates the number of divisions from a static lane to several virtual lanes, a traveling direction, a priority category designating the degrees of priority, and the like. A state of a road that includes the selected link ID and lane ID is displayed as an image, and obstacles and the like are displayed as icons.

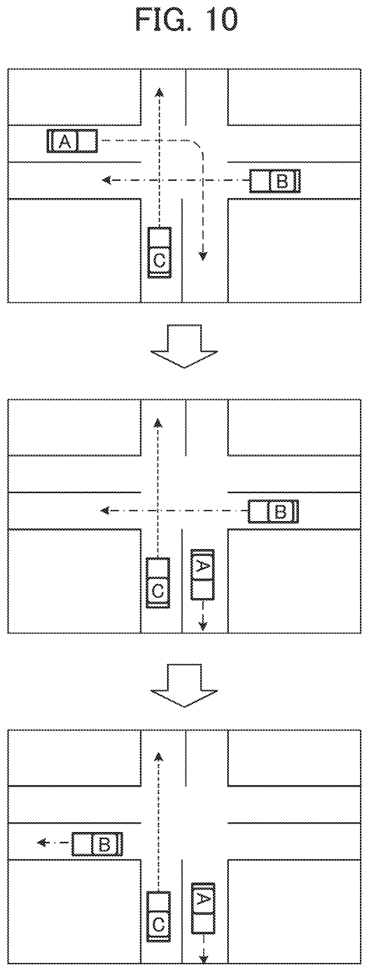

FIG. 10 is a block diagram illustrating a specific example of a passing control at an intersection. In FIG. 10, a vehicle having the degree of priority A is scheduled to turn right at the intersection, a vehicle having the degree of priority B is scheduled to advance straight at the intersection from a side opposite to the vehicle having the degree of priority A, and a vehicle having the degree of priority C is scheduled to advance straight at the intersection where the vehicle having the degree of priority C intersects with the vehicle having the degree of priority B.

In such a state, the control center 100 performs a passing control corresponding to the degree of priority instead of rules such as a rule that priority is assigned to straight advancing. Specifically, first, the vehicle having the degree of A is instructed to turn right and the vehicles having the degree of priority B and the degree of priority C are instructed to standby. Then, the vehicle having the degree of priority B is allowed to pass, and the vehicle having the degree of priority C is allowed to pass last.

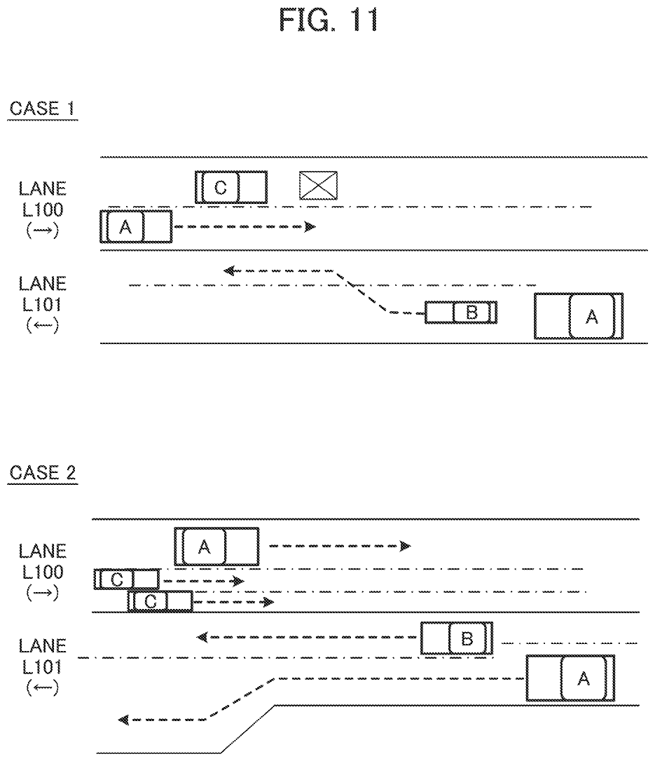

FIG. 11 is an explanatory view for describing passing control of vehicles traveling in the same direction.

In a case 1 illustrated in FIG. 11, a vehicle having the degree of priority C and a vehicle having the degree of priority A travel on a lane L100, and an obstacle exists in front of the vehicle having the degree of priority C. In such a case, the vehicle having the degree of priority C stops in front of the obstacle, waits for passing of the vehicle having the degree of priority A and, thereafter, travels on a virtual lane for avoiding the obstacle.

In the case 1 illustrated in FIG. 11, a vehicle having the degree of priority B travels on a lane L101 and a vehicle having the degree of priority A travels behind the vehicle having the degree of priority B. In this case, to allow the vehicle having the degree of priority A to overtake the vehicle having the degree of priority B, a virtual lane of the vehicle having the degree of priority B is made to approach a side of the lane. In this case, by decreasing a speed of the vehicle having the degree of priority B when necessary, a virtual vehicle width can be decreased.

In a case 2 illustrated in FIG. 11, two vehicles having the degree of priority C and a vehicle having the degree of priority A travel on the lane L100. In this case, the vehicle having the degree of priority C has a narrow vehicle width and hence, a virtual lane width for the vehicle having the degree of priority C is narrowed. Accordingly, two vehicles having the degree of priority C and the vehicle having the degree of priority A can travel parallel to each other.

In the case 2 illustrated in FIG. 11, a vehicle having the degree of priority B travels on the lane L101, and a vehicle having the degree of priority A travels behind the vehicle having the degree of priority B. Then, the standby place exists ahead in the advancing direction. Then, the vehicle having the degree of priority B is made to travel to the standby place by increasing a speed, and allows the vehicle having the degree of priority A to overtake the vehicle having the degree of priority B at the standby place.

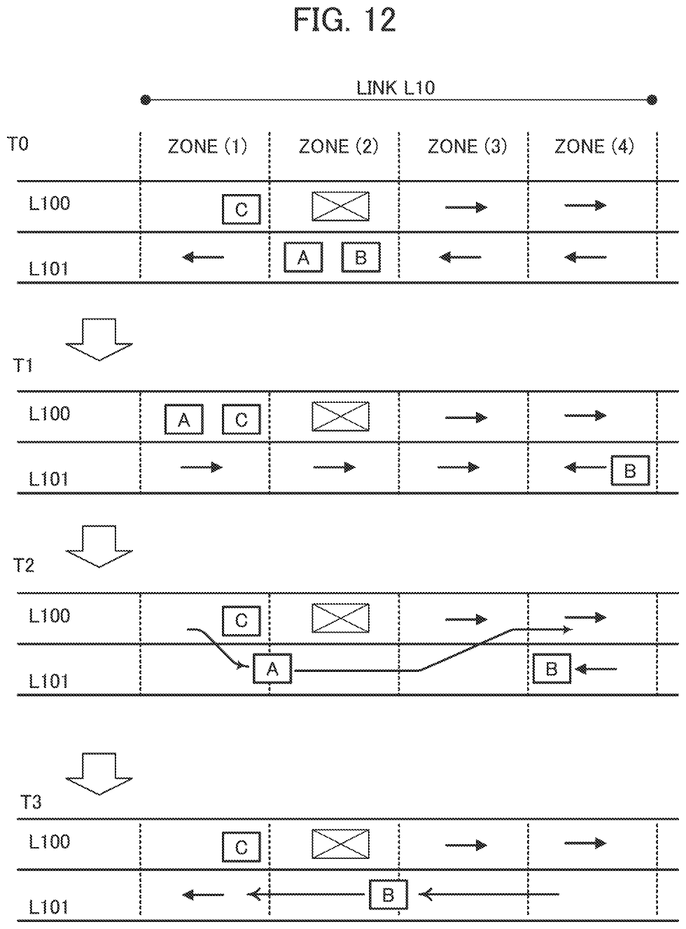

FIG. 12 is an explanatory view in a case where the direction of the lane is switched. In FIG. 12, the link L10 is divided into a zone (1) to a zone (4). The link L10 includes a lane L100 and a lane L101.

At a point of time T0, the traveling direction on the lane L100 and the traveling direction on the lane L101 are set opposite to each other. A vehicle having the degree of priority C exists in the zone (1) of the lane L100, and an obstacle exists in the zone (2). A vehicle having the degree of priority A and a vehicle having the degree of priority B exist in the zone (2) of the lane L101.

At a point of time T1, a vehicle having the degree of priority A exists behind a vehicle having the degree of priority C in the zone (1) of the lane L100, and a vehicle having the degree of priority B exists in the zone (4) of the lane L101. The traveling direction is switched in the zone (1) to the zone (3) on the lane L101 and agrees with the traveling direction on the lane L100.

At a point of time T2, the vehicle having the degree of priority A changes the lane from the zone (1) of the lane L100 to the zone (1) of the lane L101, and returns to the zone (3) of the lane L100 in the zone (3) of the lane L101.

At a point of time T3, in the zone (1) to the zone (3) of the lane L101, the traveling direction returns to the original traveling direction so that a vehicle having the degree of priority B can pass.

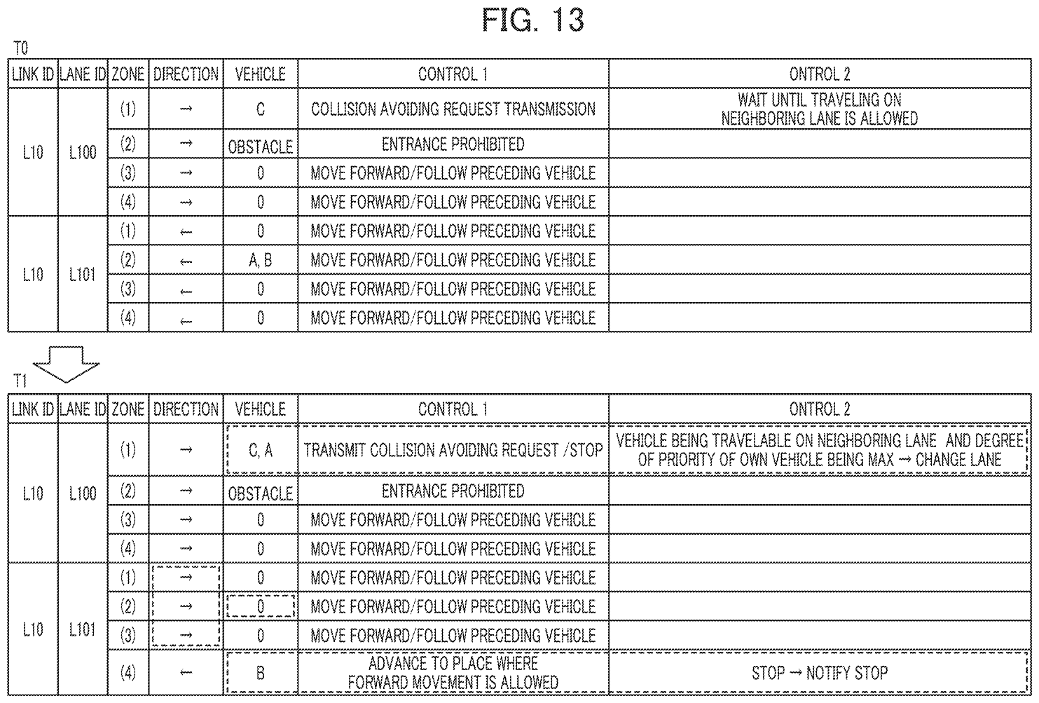

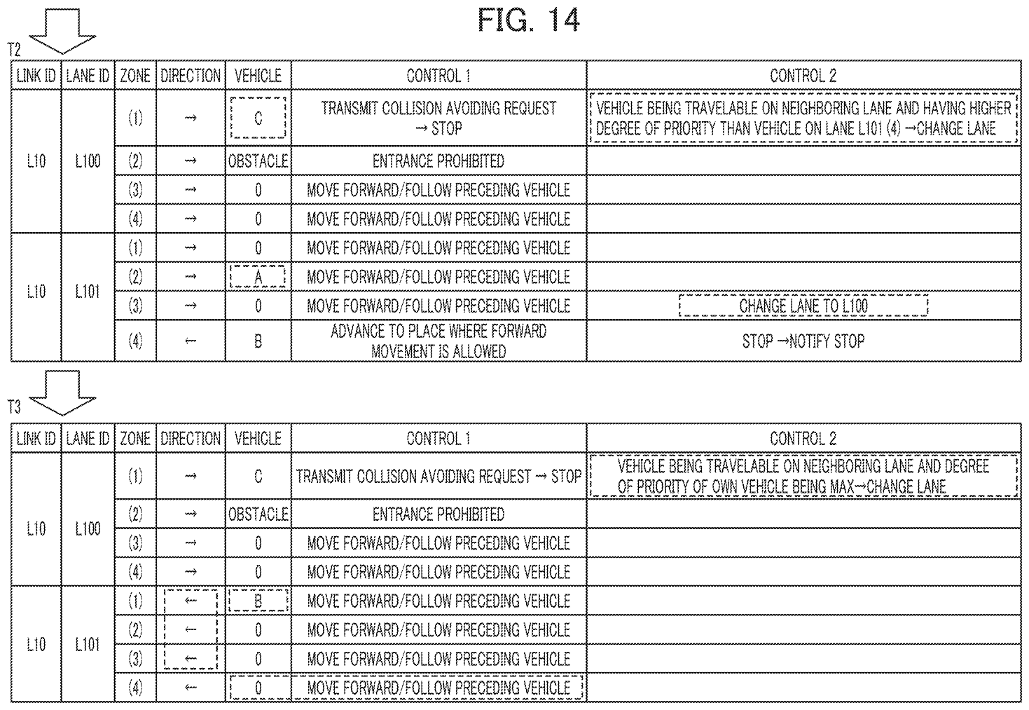

FIG. 13 and FIG. 14 are charts for describing specific examples of control information that realizes the passing control illustrated in FIG. 12. Specifically, at a point of time T0 in FIG. 13, with respect to the zone (1) of the lane L100, “transmit collision avoiding request” is set in the control 1, and “waits until traveling on the neighboring lane is allowed” is set in the control 2. With respect to the zone (2) of the lane L100 where the obstacle exists, “entrance prohibited” is set in the control 1.

With respect to a point of time T1 in FIG. 13, a differential between points of time T0 and T1 is indicated by a broken-line rectangle. More specifically, a vehicle in a zone (1) of the lane L100 is updated to “C, A”, the control 1 is updated from “transmit collision avoiding request” to “stop”, and the control 2 is updated from “vehicle being travelable on neighboring lane and the degree of priority of own vehicle being MAX” to “change lane”. Further, the directions in the zones (1) to (3) in the lane L101 become opposite, and no vehicle exists in the zone (1) of the lane L101. Further, a vehicle in the zone (4) of the lane L101 is updated to “B”, the control 1 is updated to “advance to place where forward movement is allowed”, and the control 2 is updated from “stop” to “notify stop”.

With respect to a point of time T2 in FIG. 14, a differential between a point of time T1 and the point of time T2 is indicated by a broken-line rectangle. Specifically, during a period between points of time T1 and T2, a vehicle in a zone (1) of the lane L100 is updated to “C, the control 1 is updated from “collision avoiding request transmission” to “stop”, and the control 2 is updated from “vehicle being travelable on neighboring lane and having higher degree of priority than vehicle on lane L101 (4)” to “change lane”. Further, the vehicle in the zone (2) of the lane L101 is updated to “A”, and the control 2 in the zone (3) of the lane L101 is updated to “change lane to L100”.

With respect to a point of time T3 in FIG. 14, a differential between T2 and T3 is indicated by a broken-line rectangle. Specifically, during a period between points of time T2 and T3, the control 2 in the zone (1) of the lane L100 is updated from “vehicle being travelable in neighboring lane and degree of priority of own vehicle being MAX” to “change lane”. Further, the directions in the zones (1) to (3) of the lane L101 is inverted, and the vehicle in the zone (1) of the lane L101 is updated to “B”. Then, no vehicle exists in the zone (4) of the lane L101, and the control 1 is updated to “move frontward/follow preceding vehicle”.

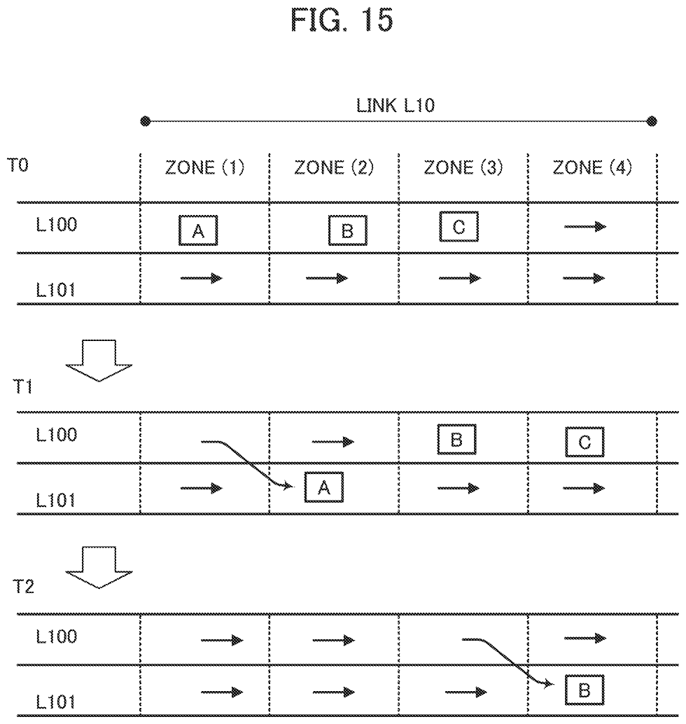

FIG. 15 is an explanatory view for describing an overtake control. In FIG. 15, the link L10 is divided into zones (1) to (4). Further, the link L10 includes a lane L100 and a lane L101.

At a point of time T0, the lane L100 and the lane L101 adopt the same traveling direction. In the lane L100, a vehicle having the degree of priority A exists in the zone (1), a vehicle having the degree of priority B exists in the zone (2), and a vehicle having the degree of priority C exists in the zone (3).

At the point of time T1, the vehicle having the degree of priority A changes the lane to the lane L101 from the zone (1) of the lane L100, and overtakes the vehicle having the degree of priority B and the vehicle having the degree of priority C. The vehicle having the degree of priority B and the vehicle having the degree of priority C advance by one zone, respectively.

At a point of time T2, the vehicle having the degree of priority B changes the lane to the lane L101 from the zone (3) of the lane L100. The vehicle having the degree of priority C advances by one zone and has left the link L10.

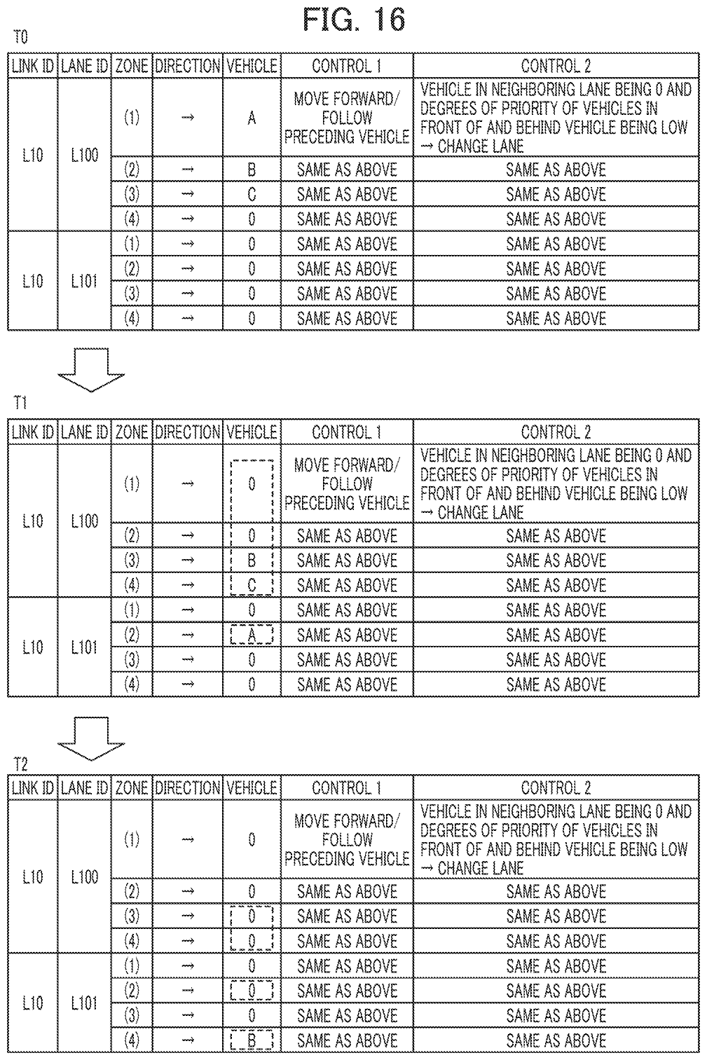

FIG. 16 is chart describing a specific example of control information for realizing a passing control illustrated in FIG. 15. Specifically, in all zones from the point of time T0 to the point of time T2, “move forward/follow preceding vehicle” is set in the control 1, and is updated from “vehicle in neighboring lane being 0 and the degrees of priority of vehicles in front of and behind the vehicle being low” to “change lane” in the control 2.

That is, in this example, it is possible to change the lane sequentially from the vehicle having the higher degree of priority without changing the control 1 and the control 2.

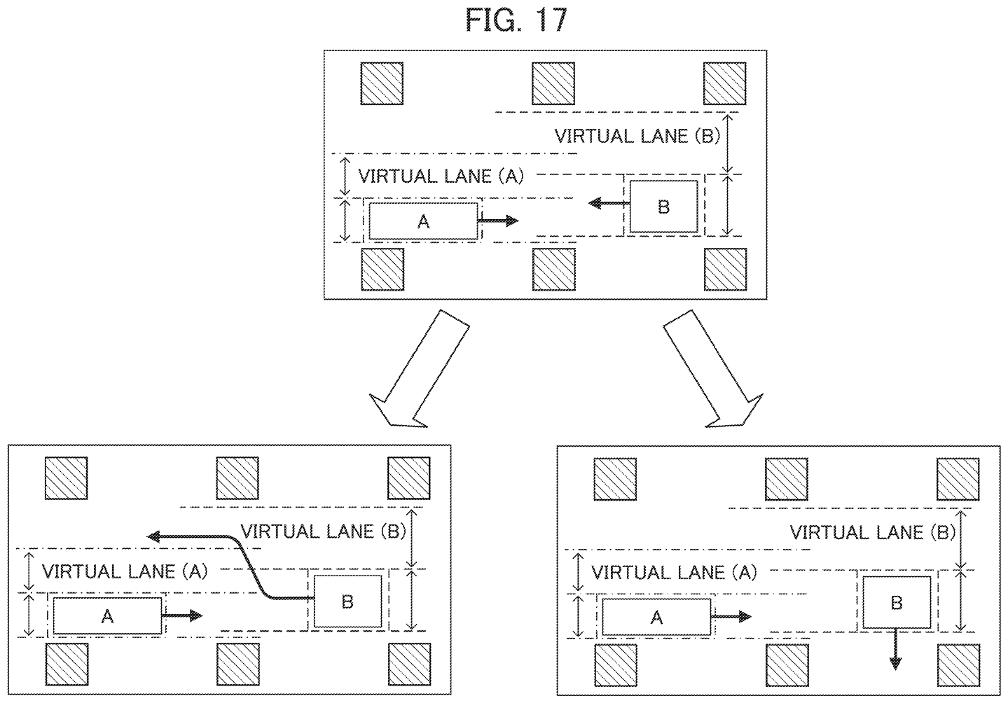

Although the case where the vehicle is a traveling body has been described heretofore, substantially the same control is applicable to other cases including a case where working robots are made to travel in a plant. FIG. 17 is an explanatory view of a traveling control of the working robots.

In FIG. 17, the working robots are traveling in a plant. The degrees of priority of the working robot are set substantially in the same manner as described. However, it is not always the case where static lanes are clearly indicated on a traveling path. Also in such a case, traveling of the working robots can be controlled by suitably setting virtual lanes.

For example, in a case where a working robot having the degree of priority A and a working robot having the degree of priority B face each other, virtual lanes are set based on sizes of the respective working robots, and control information is set such that the working robot having the lower degree of priority B gives way. When the working robot having the degree of priority B is movable in a lateral direction, it is possible to ensure an advancing path for the working robot having the degree of priority A by making the working robot having the degree of priority B retract between pillars.

As has been described above, the control system according to the embodiment includes: the traveling route control unit 111 configured to control information on the traveling path on which the traveling body travels; the traveling body position control unit 121 configured to communicate with the traveling body and configured to control at least positional information on the traveling body; the lane setting unit 122 configured to dynamically set a lane on the traveling path using at least positional information on the traveling body and a size of the traveling body; and the control information setting unit 123 configured to set control information for controlling traveling to the lane.

With such a configuration and the manner of operation, the lane can be set in conformity with the situation and a travel control can be performed. Accordingly, the traveling body can be driven efficiently.

As an example, the traveling body is a vehicle, and the traveling route control unit 111 controls the road on which the vehicle travels and the lane information statically set with respect to the road as information on the traveling path, and the lane setting unit 122 dynamically sets the virtual lane with respect to the road. Accordingly, an operation of the vehicle that travels on a road can be performed efficiently.

Further, according to the embodiment, the control system further includes the traveling body information control unit 112 configured to control the degree of priority set with respect to the traveling body, and the control information setting unit 123 sets the control information corresponding to the degree of priority set to the traveling body that exists on the lane and lanes in the periphery of the lane with respect to the lane set by the lane setting unit 122.

Accordingly, an operation of the traveling body can be controlled by taking into account the priority relationship.

As an example, the control information setting unit 123, when a plurality of traveling bodies having different degrees of priority are traveling in the same direction, sets one of the plurality of lanes as an overtake lane, and allows the traveling body having the high degree of priority to change its lane to the overtake lane and to overtake the traveling body having the low degree of priority.

Accordingly, it is possible to allow the traveling body having the high degree of priority to perform overtake driving by dynamically setting the lane.

Further, the lane setting unit 122 is characterized by setting a virtual vehicle width corresponding to a vehicle width of the traveling body while taking into account a traveling speed of the traveling body and by setting the virtual vehicle width as a width of the lane.

Accordingly, the lane can be dynamically set corresponding to an actual size of the traveling body and a speed of the traveling body.

The lane setting unit 122 performs zoning of the lane at every predetermined length, and the control information setting unit 123 sets the control information for every zone.

Accordingly, traveling of the traveling body can be controlled in detail using the control information.

According to the control system of the exemplified embodiment, the control system further includes the route control unit 113 configured to perform a route control by setting the destinations and routes of the traveling bodies. Accordingly, an operation of a plurality of traveling bodies can be controlled in a comprehensive manner.

According to the exemplified embodiment, the traveling controller mounted on the traveling body that travels on the traveling path includes: the communication unit 133 configured to communicate with the control center 100; the positional information notification unit configured to acquire positional information on the own vehicle and configured to transmit the positional information via the communication unit; and the traveling control unit configured to acquire information on the lane dynamically set on the traveling path and control information set with respect to the lane from the control center, and configured to control traveling of the own traveling body.

Accordingly, traveling can be controlled in accordance with the lane dynamically set by the control center 100, and the control information set with respect to the lane.

The present invention is not limited to the above-mentioned exemplified embodiment, and embraces various modifications. For example, the above-mentioned exemplified embodiment is described in detail for facilitating the understanding of the present invention, and is not always limited to the control system that includes all constituent elements described in the exemplified embodiment. Further, the present invention also embraces not only the deletion of the constituent elements but also the replacement and the addition of the constituent elements.

What is claimed is:

1. A control system comprising:
a traveling route control unit configured to control information on a traveling path on which a traveling body travels;
a traveling body position control unit configured to communicate with the traveling body and configured to control at least positional information on the traveling body;
a lane setting unit configured to dynamically set a lane on the traveling path using at least the positional information on the traveling body and a size of the traveling body; and
a control information setting unit configured to set control information for controlling traveling of the traveling body in the lane.

2. The control system according to claim 1, wherein
the traveling body is a vehicle, and
the traveling route control unit is configured to control a road on which the vehicle travels and lane information statically set with respect to the road as information on the traveling path, and
the lane setting unit is configured to dynamically set a virtual lane with respect to the road.

3. The control system according to claim 1, further comprising a traveling body information control unit configured to control a degree of priority set with respect to the traveling body, wherein
the control information setting unit is configured to set, with respect to a lane set by the lane setting unit, the control information corresponding to a degree of priority set to the traveling body that exists on the lane and a lane in the periphery of the lane.

4. The control system according to claim 3, wherein the control information setting unit, when a plurality of traveling bodies having different degrees of priority are traveling in the same direction, is configured to set one of a plurality of the lanes as an overtake lane, and is configured to allow the traveling body having a high degree of priority to change a lane to an overtake lane and to overtake the traveling body having a low degree of priority.

5. The control system according to claim 1, wherein the lane setting unit is configured to set a virtual vehicle width corresponding to a vehicle width of the traveling body while taking into account a traveling speed of the traveling body, and is configured to set the virtual vehicle width as a width of the lane.

6. The control system according to claim 1, wherein
the lane setting unit is configured to perform zoning of the lane at every predetermined length, and
the control information setting unit is configured to set the control information for every zone.

7. The control system according to claim 1, further comprising a route control unit configured to perform a route control by setting destination and a route of the traveling body.

8. A traveling controller mounted on a traveling body that travels on a traveling path, the traveling controller comprising:
a communication unit configured to communicate with a control center;
a positional information notification unit configured to acquire positional information on an own traveling body and configured to transmit the positional information via the communication unit; and
a traveling control unit configured to acquire information on a lane dynamically set in a traveling path and control information set with respect to the lane from the control center, and configured to control traveling of the own traveling body.

9. A controlling method comprising:
a traveling path control step of controlling information on a traveling path on which a traveling body travels;
a traveling body position control step of communicating with the traveling body and of controlling at least positional information on the traveling body;
a lane setting step of dynamically setting a lane on the traveling path using at least the positional information on the traveling body and a size of the traveling body; and
a control information setting step of setting control information for controlling traveling of the traveling body in the lane.
